(19) United States
(12) Patent Application Publication
(10) Pub. No.: US 2016/0294473 A1
(43) Pub. Date: Oct. 6, 2016

(54) METHODS FOR REDUCING OPTICAL BEAT INTERFERENCE BY CONTINUOUSLY VARYING LASER TEMPERATURES AND RELATED OPTICAL NETWORK UNITS

(71) Applicant: CommScope, Inc. of North Carolina, Hickory, NC (US)

(72) Inventors: Mark E. Alrutz, Taylorsville, NC (US); Mark O. Vogel, Statesville, NC (US)

(21) Appl. No.: 14/672,263

(22) Filed: Mar. 30, 2015

(51) Int. Cl. H04B 10/2507; H04B 10/2575; H04Q 11/00

(52) U.S. Cl. CPC H04B 10/2507; H04Q 11/0062; H04B 10/25751; H04Q 2011/0084; H04Q 2011/0086; H04Q 11/0067

(57) ABSTRACT

Methods of reducing optical beat interference are disclosed in which an output of a first temperature control system that establishes an operating temperature of a first laser that is included in a first optical network unit is controlled so that the operating temperature of the first laser varies according to a first continuous function that has a first amplitude and a first frequency and an output of a second temperature control system that establishes an operating temperature of a second laser that is included in a second optical network unit is controlled so that the operating temperature of the second laser varies according to a second continuous function that has a second amplitude and a second frequency, where the first continuous function is different than the second continuous function, the first amplitude is different than the second amplitude, and/or the first frequency is different than the second frequency.

### FIELD OF THE INVENTION

The present invention generally relates to fiber optic networks and, more particularly, to fiber optic networks that have multiple lasers transmitting optical signals to a common receiver at small wavelength separations.

### BACKGROUND

A cable television network is a well-known type of communications network that is used to transmit cable television signals and/or other information between one or more service providers and a plurality of subscribers over coaxial cables and/or fiber optic cables. Most conventional cable television networks comprise hybrid fiber-coaxial (“HFC”) networks. In these networks, fiber optic cables are typically used to carry signals from the headend facilities of the service provider to various distribution points, while less expensive coaxial cable may be used, for example, to carry the signals into neighborhoods and/or into individual customer premises. In many cases, the proportion of an HFC network that comprises fiber optic cables is increasing. For example, many HFC networks are now implemented as Fiber-to-the Curb (“FTTC”) or as Fiber-to-the-Home (“FTTH”) networks, where the fiber portion of the network may extend down residential streets in the network (in FTTC applications) or all the way to individual customer premises (in FTTH) applications. FTTC, FTTH and other fiber-heavy HTC networks may be referred to generically as “FTTx networks.”

Typically, the service provider is a cable television company that may have exclusive rights to offer cable television services in a particular geographic area. The subscribers in a cable television network typically pay the service provider to deliver various services to the “customer premises” which may include, for example, individual homes, apartments, hotels, businesses, etc. The services offered by the cable television service provider may include, for example, broadcast cable television service, broadband Internet connectivity and/or Voice-over-Internet Protocol (“VoIP”) digital telephone service. These services involve transmitting various content between the service provider and the customer premises that are delivered to the customer premises as radio frequency (“RF”) signals.

RF over Glass (“RFoG”) networks are a particular type of FTTx network. In an RFoG network, fiber optic cables are used to carry RF signals that are modulated onto laser beams for transport over the fiber optic network infrastructure. One advantage of such systems is that the network infrastructure is transparent to the RF signals, and this allows cable television network operators to continue to use the same customer premise equipment (CPE) that is used in conventional HFC networks. This equipment includes set-top boxes, DOCSIS cable modems, and DOCSIS VoIP modems, all of which are in wide use today.

In RF-based FTTx systems, an optical network unit is placed at each customer premise. These optical network units are commonly referred to as RFoG optical network units or “RONUs.” Various devices such as, for example, one or more set-top boxes, a DOCSIS cable modem, and/or a DOCSIS VoIP modem are located at the customer premise and are connected to the RONU. These set top boxes, DOCSIS modems and the like are referred to herein as customer premise equipment or as “CPE devices.” Each RONU contains a laser that is used to transmit the upstream signals from the customer premise to the head end facilities of the cable television network operator. The laser utilizes burst mode transmission in the upstream direction and is inactive until an RF signal is generated by one of the CPE devices and transmitted to the RONU over a wired or wireless RF connection. When the RF signal (which may be modified before reaching the laser) reaches the upstream laser, it activates the laser by directly modulating the optical output of the laser. When the RF burst ends, the laser in the RONU returns to its inactive state.

In a typical RFoG network, each optical fiber serves up to thirty-two customers. Thus, equipment at up to thirty-two different customer premises may all communicate over the same optical fiber. At the cable television service provider head end unit, each optical fiber is connected to a transmitter and a receiver via a wave division multiplexing unit.

Conventionally, cable television networks operating under a DOCSIS protocol transmit all of the upstream communications at a common frequency (e.g., 15 MHz) using a time division multiple access (“TDMA”) scheme. Equipment at the head end facilities control the customer premise equipment to only transmit upstream signals in pre-assigned time slots. However, under the latest version of the DOCSIS® protocol (DOCSIS® 3.1) that is used with respect to RFoG networks, the upstream RF channel may be divided into hundreds of independent sub-channels based on frequency so that upstream signals are now transmitted using a time division multiple access/frequency division multiple access (“TDMA/FDMA”) scheme. While the signals transmitted by two different CPE devices in the same time slot will be separated by frequency in the RF domain, this will not be true in the optical domain since each RF signal is used to modulate a laser that transmits optical signals at the same nominal wavelength.

The RONU at each customer premise may have a dedicated FDMA/TDMA upstream sub-channel that carries upstream communications between the RONU and the head end unit. This sub-channel is defined by a frequency band in which the RF signal is located and a time slot within the frequency band during which the RF signal is transmitted. While the CPE devices connected to the RONU at any particular customer premise may be active (i.e., transmitting) at the same time (on different FDMA channels), they are used to modulate the same laser so both RF signals are carried within the same optical signal and optical interference is avoided. However, since multiple RONUs (e.g., 32) transmit upstream signals over the same optical fiber to the headend facilities, it is possible that multiple of the RONUs that are connected to a given optical fiber may be transmitting optical signals to the head end facilities at the same time (i.e., in the same time slot) but at different RF frequencies. For example, a first RONU may be transmitting a signal from a cable modem operating on a first FDMA sub-channel in a particular time slot, while a second RONU is transmitting a signal during the same time slot from a cable modem, set-top-boxes or the like operating on a second FDMA sub-channel. In this case, there will be an optical collision at the upstream receiver at the head end unit since two RF modulated optical signals that are at the same nominal wavelength will arrive at the receiver simultaneously.

In an RFoG system, the lasers in the RONUs are typically designed to transmit optical signals at the same nominal wavelength (typically either 1310 nm or 1610 nm), which is why the above-described optical collisions may occur. However, some variation in the actual transmission wavelength is expected due to manufacturing variation and operating temperature. Thus, the lasers of the RONUs used in a particular network may be required to have center wavelengths (i.e., the wavelength at which the optical signal has a peak amplitude) within a specified wavelength range at a specified temperature, such as, for example, 1610 nm+/−1.5 nm at 25° C. While the line width of the optical signals may vary, they typically are much smaller than the expected variation in operating wavelength, such as for examples line widths of 0.001 to 0.005 nm. Accordingly, even though the lasers of two different RONUs may be transmitting optical signals to the same receiver in the same time slot at the same nominal wavelength, the optical signals may not overlap because the actual center wavelengths of the two lasers may be separated by an amount that is greater than the line widths of the optical signals due to manufacturing variation. If two optical signals are transmitted at the same time over the same optical fiber and the operating wavelengths of the two lasers do not significantly overlap, the result of the optical collision may cause some degradation in optical link performance, but this degradation can typically be handled by link margins that are present in the system.

However, it is also inevitably the case in an RFoG network that there will be instances where multiple lasers transmit signals in the same time slot at wavelengths that partially or even completely overlap. When this occurs, the optical signals interact in the optical receiver, which results in the generation of a noise product that is referred to as optical beat interference. Optical beat interference is a wideband noise having a generally uniform magnitude that may appear, for example, as an increase in the noise floor. The greater the overlap in the wavelengths of the two “colliding” optical signals, the greater the increase in the magnitude of the optical beat interference. Since optical beat interference generates a broadband noise, it may degrade all of the carriers in the upstream band, and can prevent the headend control systems for the customer premise equipment from being able to lock onto and demodulate the upstream carriers for the duration of the overlapping bursts. Similar problems will occur in any future burst if the lasers in two or more RONUs are simultaneously active and their wavelengths significantly overlap. Because of the protocols associated with the CPE devices, this could knock the devices off of the network and cause them to re-initialize on the network.

One of the difficulties in resolving this problem is that the operating wavelength of a laser is typically dependent on its temperature, and RONUs are often used in an outside plant environment where temperatures can range from −40° C. to 65° C. In addition, one RONU may be in the sun while another is in the shade, and this causes a temperature differential between the two units. The operating wavelength of a laser changes by about 0.1 to 1.0 nm/° C., depending on the design of the laser. Therefore, while a system could be designed to have lasers that transmit at different wavelengths, these wavelengths may change with changing temperature over the course of a day and these changes would not be uniform across all of the lasers. As a result, the operating wavelength (i.e., the wavelength of the optical signal transmitted by the laser) of the laser at a first RONU may partially or even completely overlap with the operating wavelength of the laser at a second RONU.

One way of addressing this problem is to use lasers at the up to thirty-two RONUs that are connected to the same head end receiver that have wavelengths that are sufficiently spaced-apart such that the wavelengths of the optical signals transmitted by the lasers will not overlap given the expected variation in wavelength over the expected temperature range. This approach theoretically eliminates wavelength overlap and therefore may prevent optical beat interference from occurring. However, because of the limited tuning range of the lasers (about 3 nm) and the shift in a laser's wavelength that may occur at activation in response to the initial surge of current from a cable modem burst, it may not be possible to deploy lasers that transmit at 32 different wavelengths in a manner that will ensure that no overlap occurs given the expected temperature variation. Thus, higher cost lasers would typically have to be used, which may not be economically feasible. In addition, this approach further increases the system cost and complexity since the lasers must be sorted into groups that meet the requirements of a particular operating window in a system or be specifically designed and fabricated for each of the wavelengths required, and network operators must stock sets of, for example, thirty-two different RONUs, each of which has a laser transmitting at a different wavelength. This may become difficult to manage when deploying and subsequently maintaining a system. This approach also takes up spectrum on the fiber that could be used to support other services such as business overlays.

### SUMMARY

Pursuant to embodiments of the present invention, methods of reducing optical beat interference at a receiver in a fiber optic network that has a plurality of optical network units communicating with the receiver over a common optical transmission path are provided. Pursuant to these methods, an output of a first temperature control system that establishes an operating temperature of a first laser that is included in a first of the optical network units is controlled so that the operating temperature of the first laser varies according to a first continuous function that has a first amplitude and a first frequency. An output of a second temperature control system that establishes an operating temperature of a second laser that is included in a second of the optical network units is likewise controlled so that the operating temperature of the second laser varies according to a second continuous function that has a second amplitude and a second frequency. The first continuous function is different than the second continuous function, the first amplitude is different than the second amplitude, and/or the first frequency is different than the second frequency.

In some embodiments, the first continuous function may vary the operating temperature of the first laser from a first nominal temperature, where the first nominal temperature may be a base temperature adjusted by a first temperature offset, and the second continuous function may vary the operating temperature of the second laser from a second nominal temperature, where the second nominal temperature may be the base temperature adjusted by a second temperature offset. The first temperature offset may be selected to be within a first predefined range and the second temperature offset may be selected to be within a second predefined range that is different than the first predefined range. The first temperature offset may also be randomly selected within the first predefined range and the second temperature offset may be randomly selected within the second predefined range. In some embodiments, the first predefined range and the second predefined range may partially overlap.

In some embodiments, the first amplitude may be different from the second amplitude and the first frequency may be different from the second frequency. The first and second amplitudes may be randomly selected within a predetermined range and/or the first and second frequencies may be are randomly selected within a predetermined range. The first continuous function may be, for example, one of a sinusoidal function or a sawtooth function. The first continuous function may be the same type of function as the second continuous function in some embodiments.

Pursuant to further embodiments of the present invention, optical network units are provided that include a laser that is adapted to generate an optical signal having a given wavelength at a given temperature, a temperature control system that is thermally coupled to the laser that establishes an operating temperature of the laser, and a controller that is configured to set the operating temperature of the laser at a predefined base temperature and to automatically vary the operating temperature of the laser within a predefined range from the base temperature pursuant to a continuous function that has a first amplitude and a first frequency.

In some embodiments, the amplitude and/or frequency of the continuous function may be different than the corresponding amplitude and/or frequency of a second continuous function that is used to automatically vary an operating temperature of a second laser of a second optical network unit within a predefined range from a second base temperature, where the second laser communicates over a common optical fiber with the first laser. In such embodiments, the base temperature may be the sum of a common base temperature and a first temperature offset, the second base temperature may be the sum of the common base temperature and a second temperature offset, and the temperature offset may be different from the second temperature offset.

In some embodiments, the temperature control system may be a thermoelectric cooler.

Pursuant to still further embodiments of the present invention, methods of reducing optical beat interference in a fiber optic network that has a plurality of optical network units having lasers that transmit at a common nominal wavelength to communicate with a shared receiver over a common optical transmission path are provided. Pursuant to these methods, a temperature control system is provided at each optical network unit that is thermally coupled to the respective laser at each optical network unit. The temperature control systems are used to establish operating temperatures of the respective lasers. The thermal output of each of the temperature control systems is automatically varied according to respective continuous functions in order to automatically vary the operating temperature of each of the lasers. At least one of the continuous functions, the amplitude of the continuous function and/or the frequency of the continuous function used to vary the thermal output of the temperature control system that establishes the operating temperature of the laser of a first of the optical network units differs from the respective continuous function, the amplitude of the continuous function and/or the frequency of the continuous function used to vary the thermal output of the temperature control system that establishes the operating temperature of the laser of a second of the optical network units.

In some embodiments, the base temperature may be assigned to the laser of each of the optical network units, where at least some of the lasers are assigned different base temperatures. In such embodiments, automatically varying the thermal output of each of the temperature control systems according to respective continuous functions in order to automatically vary the operating temperature of each of the lasers may comprise automatically varying the thermal output of each of the temperature control systems according to respective continuous functions in order to automatically vary the operating temperature of each of the lasers about the respective base temperature for each of the lasers.

In some embodiments, the amplitude and/or the frequency of at least some of the continuous functions may be selected to be within a respective predefined amplitude range or a predefined frequency range. The amplitude and/or the frequency of at least some of the continuous functions may be randomly assigned within the respective predefined amplitude or frequency range. Both the amplitude and the frequency of at least some of the continuous functions may differ from the amplitude and the frequency of at least one other of the continuous functions.

### BRIEF DESCRIPTION OF THE DRAWINGS

FIG. 1 is a schematic block diagram illustrating a portion of an RFoG network.

FIG. 2 is a schematic block diagram illustrating an optical network unit according to embodiments of the present invention that uses continuous temperature variation to randomize the optical wavelength of the laser included in the optical network unit.

FIGS. 3A-3C are graphs illustrating how the operating wavelength of a plurality of lasers that are communicating over a common optical fiber may vary as a function of time when various conventional techniques are used.

FIG. 3D is a graph illustrating how the operating wavelength of a plurality of lasers that are communicating over a common optical fiber may vary as a function of time using techniques according to embodiments of the present invention.

FIG. 4 is a graph illustrating how the operating wavelengths of a plurality of lasers may vary when each laser is associated with a thermoelectric cooler having a continuously varying temperature profile according to embodiments of the present invention.

FIG. 5 is a graph illustrating how temperature offsets may be used to further reduce the probability that two lasers that are connected to the same receiver transmit at overlapping wavelengths at the same time according to embodiments of the present invention.

FIG. 6 is a flow chart illustrating methods of reducing optical beat interference according to certain embodiments of the present invention.

### DETAILED DESCRIPTION

Pursuant to embodiments of the present invention, optical beat interference that may otherwise be generated at a receiver in a fiber optic network that simultaneously receives optical signals from multiple lasers may be reduced by continuously varying the temperatures of at least some of the lasers in order to reduce the occurrence and/or the effect of collisions between the optical signals transmitted by different lasers. The temperature variation profile may be adjusted to reduce or minimize the opportunity for lasers of different optical network units to transmit at overlapping wavelengths at the same time and/or to reduce the length of time any such overlapping occurs. In some embodiments, a sinusoidal, sawtooth or other continuous waveform may be applied to a temperature control system for each laser which may cause the wavelength of each laser to drift in a predictable manner. One or more parameters of the continuous waveform that is applied to a first temperature control system may be different from the corresponding parameter(s) of the continuous waveform that is applied to a second temperature control system so that the wavelengths of the lasers associated with the first and second temperature control systems may vary in different ways. The parameters of the continuous waveform that may be varied include, for example, the signal amplitude, signal frequency, the time that the continuous variation is implemented and intermittent delays in application of the continuous waveform.

As shown herein, by applying a continuous waveform to the temperature control systems of the lasers of optical network units that communicate over a common optical fiber at the same nominal wavelength, the operating wavelengths of the lasers may be randomized about the nominal wavelength and the amount of optical beat interference generated may be significantly reduced. Moreover, the use of continuous control signals to adjust the temperature profile of each laser may simplify the control system necessary to perform optical beat interference mitigation and/or provide improved randomization as compared to conventional techniques in which discrete control signals are used to change the temperature of the lasers in a step-wise fashion.

Embodiments of the present invention will now be discussed in further detail with reference to the attached drawings.

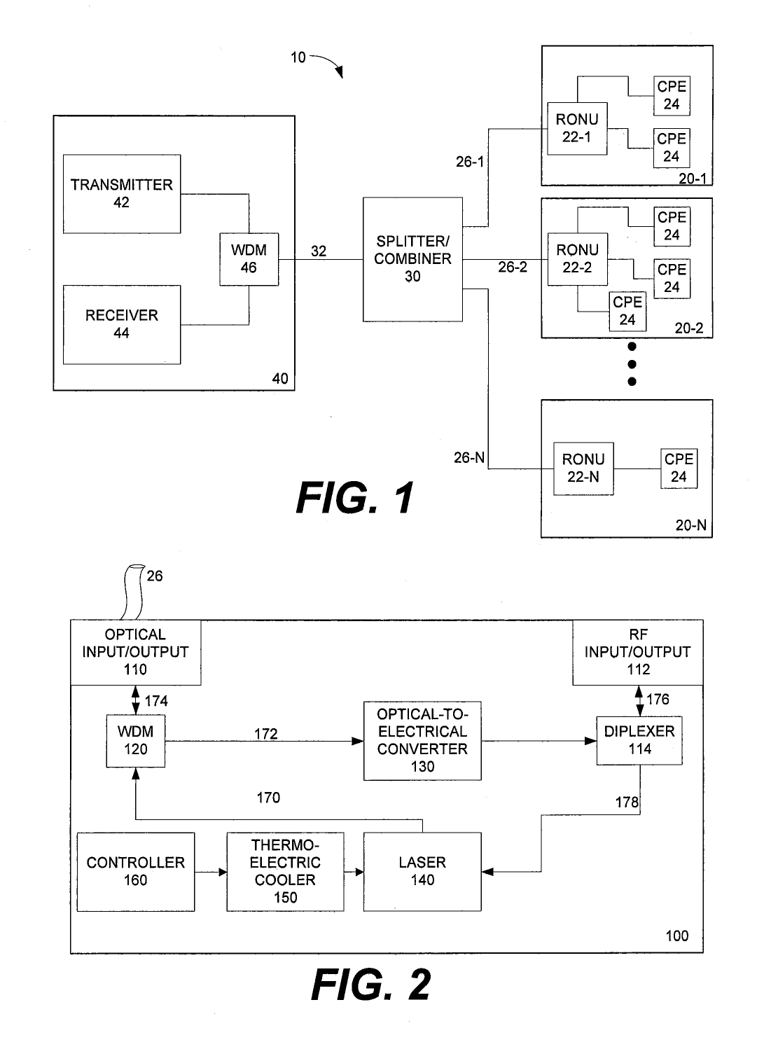

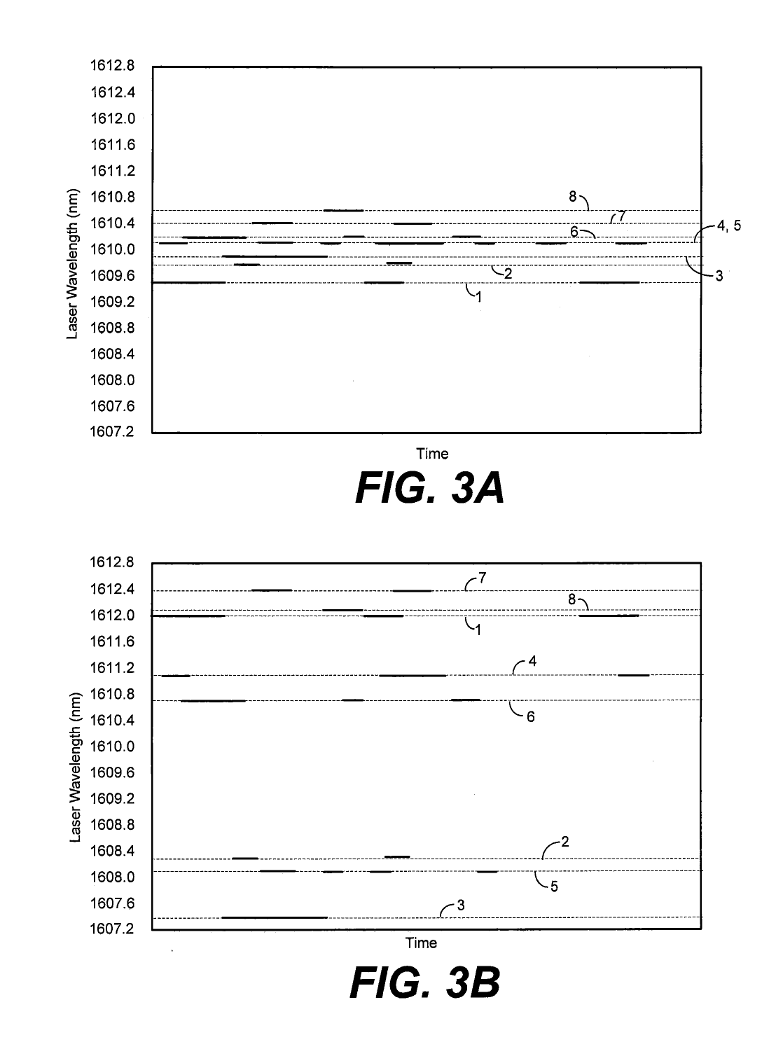

FIG. 1 is a schematic block diagram illustrating a portion of an RFoG network 10. As shown in FIG. 1, a plurality of customer premises 20-1 through 20-N are connected to a head end unit 40 of the RFoG network 10 that is located at head end facilities of the cable television service provider. Herein, when more than one of a particular element or component is provided, the component or element may be referred to individually by its full reference number (e.g., customer premise 20-2) and these components or elements may be referred to collectively by the first part of their reference numeral (e.g., the customer premises 20). An optical network unit 22 (e.g., a RONU 22) is located at each customer premise 20. Each optical network unit 22 includes a laser (see FIG. 2) that is used to transmit upstream signals. In an RFoG network such as network 10, the lasers in the optical network units 22 are typically all designed to transmit at the same nominal wavelength (e.g., 1610 nm). One or more CPE devices 24 such as set top boxes, cable modems or VoIP modems may be connected to each optical network unit 22. Each optical network unit 22 is connected by an optical fiber 26 of a fiber optic cable to an optical splitter/combiner 30. The splitter/combiner 30 is connected by an optical fiber 32 of a fiber optic cable to the head end unit 40 (or, more typically, by a network of optical fibers and intervening equipment). The head end unit 4Q may include a transmitter 42, a receiver 44 and a wave division multiplexer 46. The upstream signals transmitted over the optical fibers 26-1 through 26-N are combined at the splitter/combiner 30 and transmitted over the single optical fiber 32 (or over a series of optically connected optical fibers) to the head end unit 40.

The optical network unit 22 may be an enclosure that houses equipment for converting downstream optical signals carried on an incoming fiber optic cable into electrical signals that can be used by a local network such as, for example, the coaxial cable network within an individual customer premise that carries the cable television, broadband Internet and/or VoIP telephone signals into individual rooms in the premises. The optical network unit also converts upstream signals received from the customer premise network into optical signals that are transmitted back to the head end unit. In an RFoG environment, the optical network unit 22 typically marks the demarcation point between the outside fiber plant that is controlled by the cable television service provider and the customer-owned network wiring.

The optical splitter/combiner 30 may comprise, for example, a 1×N optical splitter/combiner that splits a downstream optical signal that is received from optical fiber 32 N-ways and outputs the split signal onto the N optical fibers 26-1 through 26-N for delivery to the optical network units 22-1 through 22-N at the customer premises 20-1 through 20-N. Typically, N will be equal to thirty-two under the RFoG standard ANSI/SCTE 174 2010. The optical splitter/combiner 30 will likewise combine the upstream optical signals received over the optical fibers 26 into a composite upstream signal and then output that composite upstream signal onto optical fiber 32. The optical splitter/combiner 30 may comprise a passive device. It will be noted that the splitter/combiner 30 may be implemented as multiple smaller splitters (e.g., 1×8 and/or 1×4 splitters). The splitter/combiner 30 may also be replaced with one or more optical tap units.

The wave division multiplexer 46 may receive downstream optical signals transmitted by the transmitter 42 and output them onto the optical fiber 32 and may also receive the composite upstream optical signal from optical fiber 32 and output this composite upstream signal to the receiver 44. The upstream and downstream optical signals are at different wavelengths which allows the wave division multiplexer 46 to correctly route the upstream and downstream optical signals in this manner.

As discussed above, under the current DOCSIS 3.1 protocol, the CPE devices 24 that are connected to the optical network units 22 may send RF signals to more than one of the optical network units 22 at the same time. As each optical network unit 22 uses these RF signals to directly modulate the lasers that are included in the optical network units 22, multiple optical signals may be transmitted, at the same time, from the plurality of optical network units 22 to the optical receiver 44 over the same optical fiber. Moreover, since the lasers at the optical network units 22 are all designed to transmit at the same nominal wavelength, such simultaneously transmitted signals may also overlap in wavelength, depending upon the actual nominal center wavelength of each laser and the temperature of the optical network units 22 (which also effects the transmission wavelength). If two optical signals that are transmitted at the same time also overlap sufficiently in wavelength, then optical beat interference may arise, which may degrade the signal quality or even prevent the head end equipment from maintaining lock on and demodulating the upstream signals during the period of overlap.

A method of mitigating the effects of optical beat interference that has been proposed is disclosed in U.S. Pat. No. 8,295,704 (“the '704 patent”), which is assigned to the assignee of the present application. The entire contents of the '704 patent are incorporated herein by reference as if set forth fully herein. Under the approach of the '704 patent, the lasers of optical network units that share a common optical fiber connection to a head end receiver are randomly assigned a temperature offset value from a base temperature, where the temperature offset value is within a predefined temperature offset range. By way of example, the base temperature might be selected as 25° C., and the temperature offset range might by +/−10° C. from this base temperature (i.e., from 15° C. to 35° C.). Each optical network unit includes a controller that controls the output of a thermoelectric cooler that is thermally connected to the laser of the optical network unit that attempts to set the temperature of the laser at a pre-assigned temperature which is equal to the base temperature as modified by the assigned temperature offset value. Thus, for example, if the base temperature is 25° C. and the temperature offset assigned to a particular laser is +5° C., then the controller will control the thermoelectric cooler for that laser to heat or cool the laser in an effort to maintain the temperature of the laser at approximately 30° C.

Additionally, under the approach of the '704 patent, temperature dithering is performed at each laser, whereby the temperature of each laser is varied over time from its assigned temperature offset value. To dither the laser temperature, the '704 patent teaches that a dithering range is selected (e.g., +/−1.5° C.) and a minimum dithering increment is selected (e.g., 0.25° C.). Each laser may then randomly establish a dithering increment that is greater than the minimum dithering increment and less than the maximum value of the dithering range, and a direction for dithering (i.e., increasing temperature or decreasing temperature). The optical network unit will use the dithering increment to increase or decrease the temperature of the laser at each dithering time (i.e., a time when the dithering increment is applied) until the temperature is at the edge of the dithering range. When this occurs, the direction of the dithering increment is changed (i.e., if the dithering increment had been used to increase the temperature, it is then used to decrease the temperature) until the other end of the range is reached, and then the process repeats. Thus, the temperature of each laser is dithered about the assigned offset temperature. To provide further randomization, at each dithering time the controller for a given laser may randomly select a value (e.g., a value within the range of 0 to 1) and if the selected value is within a predefined dithering activation range (e.g., 0 to 0.2), the dithering increment is applied, but otherwise it is not.

Thus, under the approach of the '704 patent, each laser may have a randomly selected temperature offset value, and the temperature of each laser may be further changed by dithering the temperature about the offset value using a randomly selected dithering increment that may be intermittently (and somewhat randomly) applied. In the example provided above, the thermoelectric cooler for the laser with the +5° C. temperature offset from a base temperature of 25° C. would dither the temperature of the laser about a temperature of 30° C. As a result of this temperature variation, if two lasers end up transmitting at the same wavelength, they will only do so for a limited time period due to the dithering of the laser temperatures. This approach may reduce the effects of optical beat interference.

Pursuant to embodiments of the present invention, it has been realized that a continuous control signal may be applied to vary the temperature of each laser in a manner that may be simpler than the step-wise approach discussed in the '704 patent. Moreover, the use of a continuous control signal may result in more effective reduction of optical beat interference at the receiver 44, as it may result in smaller periods of time where two lasers transmit at overlapping wavelengths. In particular, the smaller periods of overlap may result in shorter burst errors which the receiver 44 may be able to correct using interleaving and error correction coding.

FIG. 2 is a schematic block diagram illustrating an optical network unit 100 according to embodiments of the present invention that uses continuous temperature variation to randomize the optical wavelength of a laser 140 that is included in the optical network unit 100.

As shown in FIG. 2, the optical network unit 100 may include an optical input/output 110 for receiving an optical fiber of the RFoG network (i.e., optical fiber 26 in FIG. 1) and an RF input/output 112 is provided for passing RF signals between the optical network unit 100 and, for example, CPE devices 24 that are located at a customer premise 20. It will be appreciated that the RF input/output 112 may be a wired input/output port such as a coaxial connector that receives a coaxial cable or, alternatively, may be a wireless connection that transmits and receives RF signals. The optical network unit 100 may also include a diplexer 114, a wave division multiplexer 120, an optical-to-electrical converter 130 and an electrical-to-optical converter in the form of a laser 140.

The wave division multiplexer 120 receives downstream signals transmitted to the optical network unit 100 over the optical fiber 26 and outputs these signals to the optical-to-electrical converter 130. The wave division multiplexer 120 also receives upstream optical signals that are transmitted by the laser 140 and outputs such upstream signals onto the optical fiber 26 via the optical input/output 110. The upstream and downstream optical signals are at different wavelengths, which allows the wave division multiplexer 120 to correctly route the upstream and downstream signals in this manner.

The optical-to-electrical converter 130 may convert downstream optical signals received from the wave division multiplexer 120 to RF signals that can be transmitted over electrical conductor(s) such as, for example, coaxial cables of the customer premise network. The optical-to-electrical converter 130 may comprise, for example, a photodiode that outputs electrical signals in response to the received downstream optical signals. The optical-to-electrical converter 130 may pass the downstream signals to the diplexer 114 once they have been converted to RF signals. The diplexer 114 passes these downstream signals to the RF input/output 112 for transmission onto the customer premise network.

Upstream RF signals that are received from the customer premise network at the RF input/output 112 are passed to the diplexer 114. The diplexer 114 passes these upstream RF signals to the laser 140. The laser 14Q is used to convert the upstream RF signals that are received from the customer premise network into upstream optical signals that are passed to the optical input/output 110 via the wave division multiplexer 120. The upstream and downstream RF signals are at different frequencies which allows the diplexer 114 to correctly route the upstream and downstream signals in the manner described above.

A first optical pathway 170 carries optical signals from the laser 140 to the wave division multiplexer 120, a second optical pathway 172 caries optical signals from the wave division multiplexer 120 to the optical-to-electrical converter 130, and a third optical pathway 174 connects the wave division multiplexer 120 to the optical input/output 110. A first coaxial cable 176 carries RF signals between the RF input/output 112 and the diplexer 114, and a second coaxial cable 178 carries RF signals between the diplexer 114 and the laser 140.

As is further shown in FIG. 2, the optical network unit 100 further includes a thermoelectric cooler 150 that is thermally connected to the laser 140 and a controller 160. In a typical embodiment, the thermoelectric cooler 150 may have a platform that may be heated or cooled. The laser 140 may, for example, be mounted on this platform and the thermal transfer may occur from the direct physical contact of the laser 140 to the platform 150. The controller 160 may be used to establish the temperature of the temperature-controlled platform of the thermoelectric cooler 15Q and thus the operating temperature of laser 140.

The laser 14Q may be designed to operate at a nominal wavelength such as, for example, 1610 nanometers. Moreover, the lasers 140 of other optical network units 100 that are in communication with the same head end receiver 44 over the same optical fiber 32 may also be designed to operate at this same nominal wavelength. As will be discussed in more detail below, in order to reduce the probability that two such lasers 140 transmit optical signals at the same time that overlap in wavelength, the temperature of each laser 140 may be continuously varied, which will cause the transmission wavelength of each laser 140 to vary in the same fashion.

In some embodiments, the controller 160 controls the output of the thermoelectric cooler 150 so that the temperature of the laser 140 is varied in a continuous fashion. For example, the controller 160 may apply a control signal to the thermoelectric cooler 150 in the form of a signal that continuously varies according to a predefined function to cause the thermoelectric cooler 150 to continuously vary the temperature of the temperature-controlled platform according to the predefined function. In some embodiments, the temperature of the temperature-controlled platform of the thermoelectric cooler 150 may vary in a sinusoidal fashion about a base or nominal temperature in response to the continuous control signal. The amplitude, frequency and/or other parameters of the continuous function may be preselected, randomly selected or randomly selected within one or more preselected ranges of values. It will also be appreciated that continuous functions other than sinusoidal functions may be used such as, for example, sawtooth functions or any other continuously varying waveform. In some embodiments, the amplitude of the continuous waveform that represents the temperature variation may be different for different lasers. In some embodiments, the frequency of the continuous waveform that represents the temperature variation may be different for different lasers. By varying these and/or other parameters it has been found that optical beat interference may be reduced.

Control circuitry for accurately controlling the temperatures of lasers to tenths of a degree Celsius are known from dense wavelength divisional multiplexing (DWDM) systems. Suitable controllers for maintaining the temperature of a thermoelectric cooler and associated laser are available, for example, from Maxim Integrated Products of Sunnyvale, Calif., which are adapted to rapidly respond to temperature changes to maintain a thermoelectric cooler at a required temperature. Other suitable controllers for maintaining thermoelectric cooler temperature could alternately be used. Such controllers may be modified to apply control signals that continuously vary the temperature in predefined ways pursuant to embodiments of the present invention. It will be appreciated that the controller 160 may be a stand-alone controller or may be part of the thermoelectric cooler 150. It will also be appreciated that temperature control systems other than thermoelectric coolers may be used.

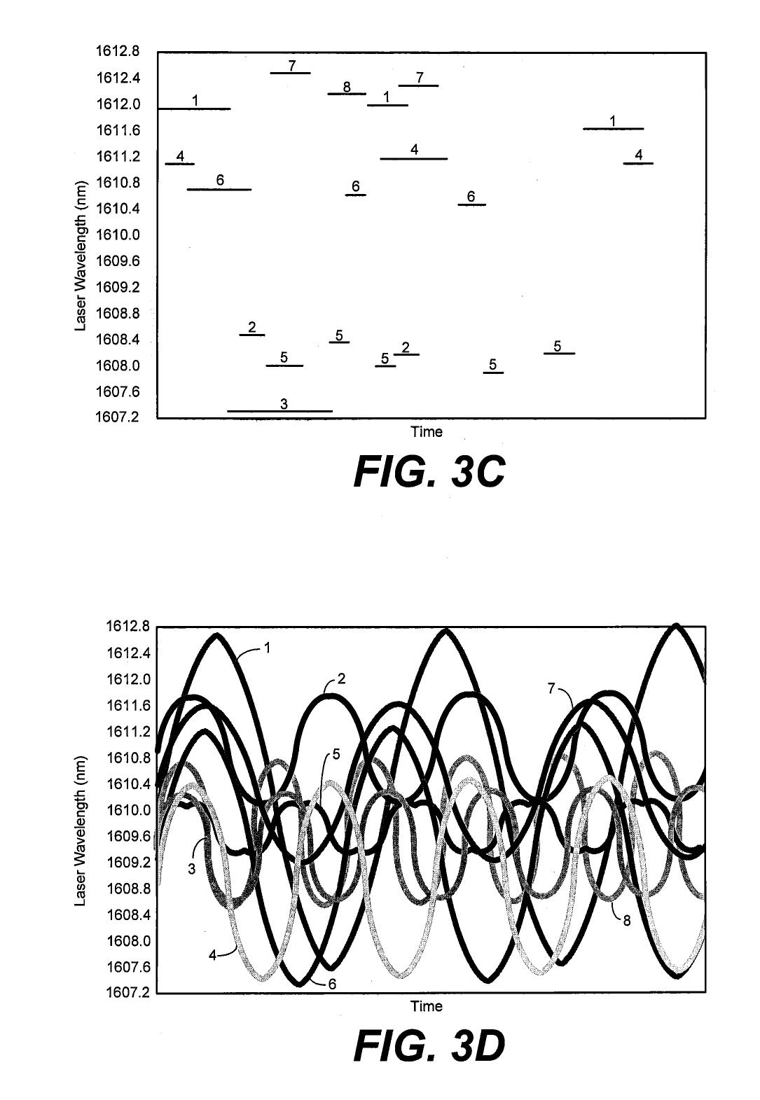

Before describing techniques for continuously varying the temperature of lasers that are communicating over a common optical fiber, it is helpful to review various conventional techniques for transmitting upstream signals in an RFoG network. In particular, FIGS. 3A-3C are graphs illustrating how the operating wavelength of a plurality of lasers that are communicating over a common optical fiber may vary as a function of time for when various conventional techniques are used.

FIG. 3A is a graph of the operating wavelength of the lasers of eight different optical network units as a function of time that illustrates one conventional technique for transmitting upstream signals in an RFoG network. In generating the graph of FIG. 3A, it was assumed that all eight optical network units had lasers that were designed to transmit at a nominal design wavelength of 1610 nm at room temperature (25° C.), and that the lasers in all eight optical network units were maintained at 25° C. It was also assumed that due to manufacturing variation, the actual operating wavelength of the eight optical network units at room temperature varied by as much as +/−0.6 nm from the nominal design wavelength. For the particular example shown in FIG. 3A, it was assumed that the actual operating wavelengths of the eight lasers at 25° C. were 1609.5 nm for the first laser, 1609.8 nm for the second laser, 1609.9 nm for the third laser, 1610.1 nm for the fourth laser, 1610.1 nm for the fifth laser, 1610.2 nm for the sixth laser, 1610.4 nm for the seventh laser, and 1610.6 nm for the eighth laser due to such manufacturing variation. These values were randomly selected but are representative of the type of variation that may be expected in practice. It was also assumed that the line width of the signal transmitted by each laser was 0.005 nm. Finally, in the example of FIG. 3A, it is assumed that the lasers in all eight optical network units are transmitting optical signals onto a common optical fiber.

In FIG. 3A, the dotted lines that extend horizontally across the graph show the wavelength at which each of the eight lasers may transmit optical signals. Each dotted line is assigned a reference numeral between 1-8 to indicate which laser the dotted line corresponds to. As noted above, it has been assumed that the line width of each optical signal is 0.005 nm at 25° C. As these line widths are very small in comparison to the variation in operating wavelength as a result of manufacturing variation (which is assumed here as +/−0.6 nm which corresponds to a 1.2 nm range), in this example none of the line widths of the eight lasers are overlapping, which would typically be the case.

The horizontal axis in the graph of FIG. 3A represents time. As discussed above, the CPE devices 24 transmit under an FDMA/TDMA scheme and hence will not continuously transmit signals, but instead will only intermittently transmit upstream signals. In the graph of FIG. 3A, the solid bold line segments that are superimposed on each of the dotted lines show the times where each of the eight lasers are assumed to be transmitting. As noted above, none of the lasers have operating wavelengths that are sufficiently close together (i.e., within 0.005 nm) so that the line widths of the signals transmitted by the two lasers will overlap. However, when an RF burst is applied to a laser, the rush of current heats up the laser which may cause a shift in the operating wavelength of the laser. Thus, even though the nominal operating wavelength of the laser may be spaced apart by more than the line width, when modulated the lasers may still interfere with each other. Typically, if the center wavelengths of two lasers are separated by at least 0.2 nm, those lasers will not generate optical beat interference when transmitting signals at the same time. However, if the center wavelengths are separated by less than this amount, then optical beat interference will start to arise, and will get worse with decreasing separation.

Referring to FIG. 3A, the lasers that have an operating wavelength that is at least 0.2 nm different from the operating wavelength of all of the other lasers will generally not give rise to any optical beat interference. The first, seventh and eighth lasers fall into this category. However, the second, third, fourth, fifth and sixth lasers have operating wavelengths that are within about 0.2 nm of at least one other laser. As a result, transmissions by each of these lasers may occur at the same time as another of the lasers and in a wavelength separation that may give rise to optical beat interference. In the example of FIG. 3A, optical beat interference may occur between (1) the fourth and sixth lasers, (2) the second and third lasers and (3) the fourth and fifth lasers.

As discussed above, the '704 patent teaches that a random temperature offset may be used to reduce how frequently two lasers simultaneously transmit at closely spaced or overlapping wavelengths. FIG. 3B illustrates how the randomized temperature offset that is disclosed in the '704 patent may be used to reduce the probability of optical beat interference by applying such random temperature offsets in the example of FIG. 3A. In the graph of FIG. 3B, it is assumed that a random temperature offset is applied to each of the eight lasers. The range of the temperature offsets is selected so that the temperature offsets will generally tend to spread the operating wavelengths of the eight lasers out over a wider wavelength range. In the example of FIG. 3B, it was assumed that the random temperature offsets that were applied to the eight lasers resulted in wavelength offsets of 2.5 nm for the first laser, −1.5 nm for the second laser, −2.5 nm for the third laser, 1 nm for the fourth laser, −2 nm for the fifth laser, 0.5 nm for the sixth laser, 2 nm for the seventh laser, and 1.5 nm for the eighth laser, thereby shifting the operating wavelengths of the first through eights lasers at 25° C. to 1612.0 nm, 1608.3 nm, 1607.4 nm, 1611.1 nm, 1608.1 nm, 1610.7 nm, 1612.4 nm, and 1612.1 nm, respectively. As is readily apparent, the offsets spread out the operating wavelengths over a wider range of wavelengths, thereby reducing the probability of optical beat interference. However, even with only eight lasers in the example (as opposed to thirty-two lasers in a standard RFoG system), it can also be seen that the operating wavelengths at 25° C. for two of the lasers (the first and eighth lasers) are separated by less than 0.2 nm and hence may give rise to optical beat interference if the lasers are transmitting simultaneously.

FIG. 3C illustrates the operating frequency of the eight lasers of FIG. 3B when the step-wise dithering technique that is disclosed in the '704 patent is further added. As shown in FIG. 3C, instead of staying at a constant operating wavelength, the operating wavelength for each laser may randomly move in a step wise fashion over a relatively small wavelength range. This has the potential to further randomize the instantaneous operating wavelengths of the eight lasers. However, as can also be seen from FIG. 3C, because of the step-wise nature of the dithering, two lasers may be at operating wavelengths that are within 0.2 nm of each other for multiple time increments. If the lasers are both transmitting when this occurs, significant optical beat interference may arise that may extend over multiple packets, resulting in burst errors. The receiver 44 may be unable to recover these burst errors, resulting in lost data.

As discussed above, pursuant to embodiments of the present invention, the thermoelectric cooler 150 may vary the temperature of the laser 140 in each optical network unit 100 according to a continuous function such as, for example, a sine wave function, a sawtooth function, etc. As a result, the operating wavelength of each laser 140 may also vary according to a continuous function, as is shown in FIG. 3D. In particular, FIG. 3D illustrates the operating wavelengths for eight lasers 140 as a function of time that may all be transmitting onto a common optical fiber. As the temperature of each laser 140 is varied according to a continuous function, the operating wavelength of each laser 140 will also vary continuously. As can be seen in FIG. 3D, the use of a continuous function may result in more occurrences where two lasers 140 may potentially transmit at potentially overlapping wavelengths. However, the duration of these overlapping period may be much shorter.

Since the transmitted signals may be error correction coded (e.g., Reed-Solomon coding or concatenated encoding including Viterbi coding and Reed-Solomon coding) and since interleaving may be incorporated into the receivers 44, once the RF signal is recovered at the receiver 44 it may be possible to further spread out burst errors that result from, for example, optical beat interference and also to correct errors using the error correction encoding/decoding. Since the continuous waveform tends to result in shorter bursts of errors, it may be more likely that these errors can be further spread out by the interleaving and then corrected by the error correction encoding. Thus, it is believed that by varying the output of the thermoelectric cooler 150 according to a continuous function it may be possible to obtain improved performance while using a simpler control system.

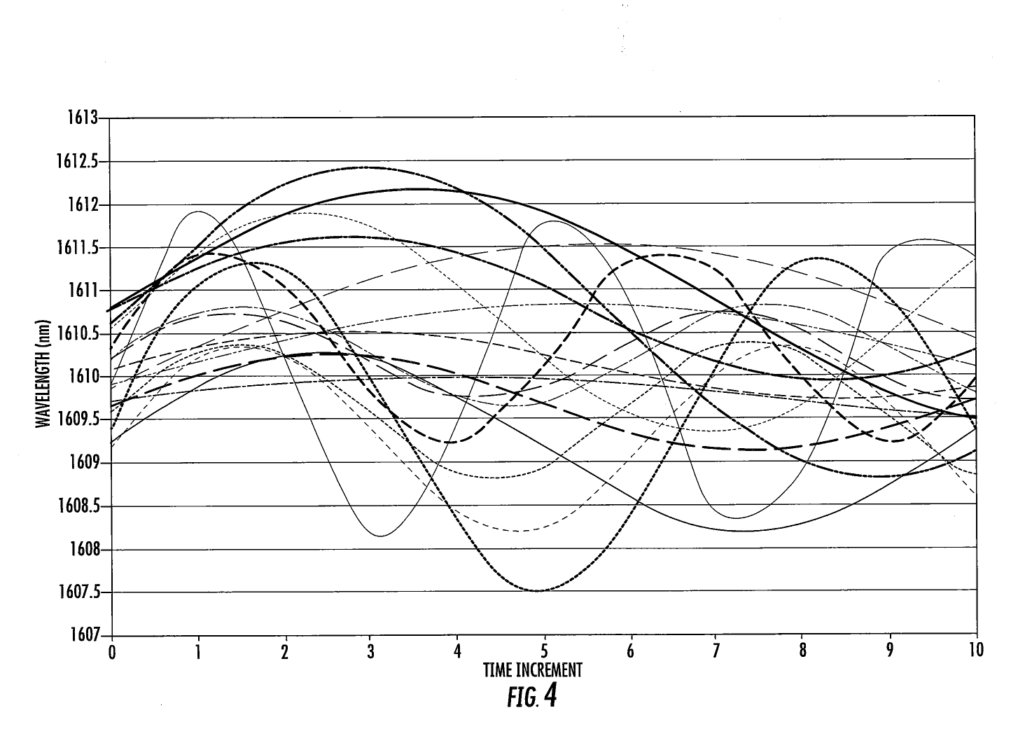

Two parameters of the continuously varying temperature profile that may be changed are (1) the amplitude swing of the temperature change and (2) the frequency of the change. The amplitude will affect the range over which the wavelength of the laser 140 will continuously drift and the frequency will affect how quickly the wavelength changes from its minimum to maximum values. FIG. 4 is a graph illustrating how the operating wavelengths for seventeen lasers 140 may vary when each laser 140 is associated with a thermoelectric cooler 150 having a continuously varying temperature profile based on continuous functions that are similar to sine waves that have different frequencies and amplitudes that were selected within predetermined ranges.

The parameters such as signal amplitude and frequency of the continuously varying temperature profile may be set to reduce or minimize the opportunity for lasers 140 in different optical network units 100 to transmit signals in overlapping wavelength ranges at the same time. In addition to signal amplitude and frequency, other parameters that may be adjusted include signal initiation, which refers to the point in time at which the continuously varying temperature profile is applied, and intermittent delays, which refer to interruptions in a continuously varying temperature profile where the temperature is held constant for a period of time. As yet another option, more than one continuous function may be applied to a thermoelectric cooler 150 associated with a given laser 140 (e.g., a first continuous function is applied during a first time period, a second continuous function is applied during a second time period, etc.). In some cases, the parameters of the continuous waveforms may be randomly selected for each optical network unit 100. In other cases, the parameters may be randomly selected within a predefined range or sub-range. In other embodiments, some or all of the parameters may be pre-selected to provide improved optical beat interference performance.

In some embodiments, selection of randomized amplitudes, frequencies, start times and intermittent delays may be accomplished by very simple means. For example, the start times may be randomized by simply using the time of unit power on for each unit. More complex methods or algorithms may also be used.

As one example, an external temperature and/or a device temperature may be used to set one or more of the parameters of the continuous function (e.g., amplitude, frequency, etc.) that is used to vary the temperature profile. As another example, the input RF or optical power levels may be used to set one or more of the parameters of the continuous function used to vary the temperature profile. As yet another example, burst timing could be used to set a parameter. In still other embodiments, a mechanical switch or a programmable interface may be used to set a parameter of the continuous function. The variation ranges may be limited by the functional capabilities of the circuitry and the lasers.

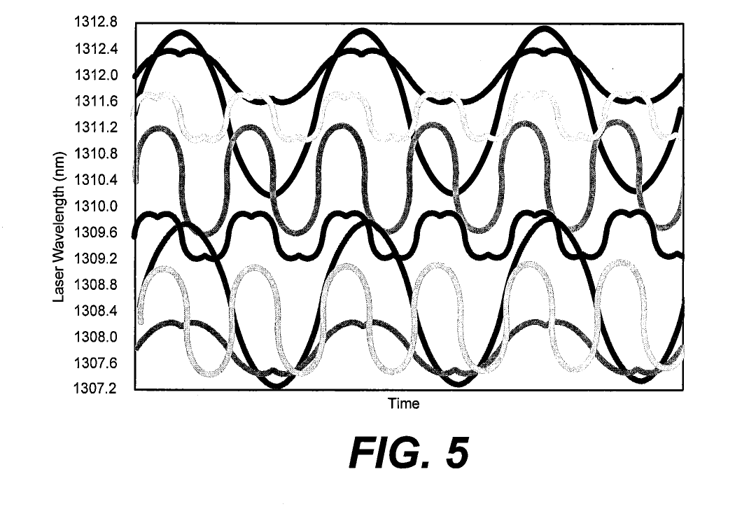

It will likewise be appreciated that initial temperature offsets may also be used in some embodiments to further reduce the probability that two lasers transmit signals in overlapping wavelength ranges at the same time. For example, FIG. 5 illustrates an embodiment in which eight optical network units that share a common receiver are each assigned a different initial temperature offset variation. In the embodiment depicted in FIG. 5, the optical network units 100 were divided into two different groups of four optical network units 100 each. A base temperature was then selected such as, for example, 25° C., as was a temperature offset range of, for example, +/−10° C. This temperature offset range may then be divided into sub-ranges. For example, in the embodiment of FIG. 5, the temperature offset range was divided into two sub-ranges, namely a first range of 0 to 10° C. and a second range of 0 to −10° C. The four optical network units 100 in the first group were randomly assigned a temperature offset in the first range, and the four optical network units 100 in the second group were randomly assigned a temperature offset in the second range.

In the example of FIG. 5, it is assumed that each change of 1 degree in the temperature of a laser 140 (from a starting temperature of about 25° C.) will result in a 0.1 nm change in the operating wavelength of the laser 140. Accordingly, the randomly selected temperature offsets applied to each optical network unit 100 in the first group will increase the operating wavelength of the lasers 140 in the optical network units 100 of the first group by between 0 nm and 1.0 nm. Similarly, the randomly selected temperature offsets applied to each optical network unit 100 in the second group will decrease the operating wavelength of the lasers 140 in the optical network units 100 of the second group by between 0 and 1.0 nm. In this embodiment, the signal amplitudes of the continuous functions used to vary the temperature profile were randomly selected to result in a wavelength variation of between 0.5 and 2.5 nm, and the frequency of the continuous functions used to vary the temperature profile were randomly selected to have values that resulted in periods of between 1 and 3 time increments.

The controller 160 in each optical network unit 100 may set the temperature of its associated thermoelectric cooler 150 to the base temperature (e.g., 25° C.) plus the selected offset temperature. As can be seen in FIG. 5, such a system may spread the operating wavelengths of the eight lasers 140 more effectively over a larger range of values, and hence may further reduce the number of occurrences where two lasers 140 transmit signals that are within 0.2 nm of each other at the same time. The random selection of the temperature offsets allows for an increased variance without requiring controllers 160 in different optical network units 100 to communicate with one another. If communication between optical network units 100 is provided for other reasons, the above-described offset temperatures could be assigned to be mutually different. Alternately, the offset temperatures could be preset at each optical network unit 100 at installation to be mutually different rather than using random selection within sub-groups.

In the example of FIG. 5, the optical network units 100 were divided into two different groups and a temperature offset within a first range was applied to the optical network units 100 in the first group, and a temperature offset within a second range was applied to the optical network units 100 in the second group. It will be appreciated that in other embodiments, all of the optical network units may be placed within a single group. For instance, the example of FIG. 5 could be modified so that every optical network unit 100 was in the same group and was assigned a temperature offset within the range of +/−10° C. In other embodiments, more than two groups may be provided. The temperature offsets for different groups may or may not overlap. The use of multiple groups may increase the probability that the continuous waveforms more evenly distribute the operating wavelengths throughout a desired range of wavelengths so that the occurrences where two lasers 140 transmit at wavelengths that are separated by less than 0.2 nm at the same time is reduced.

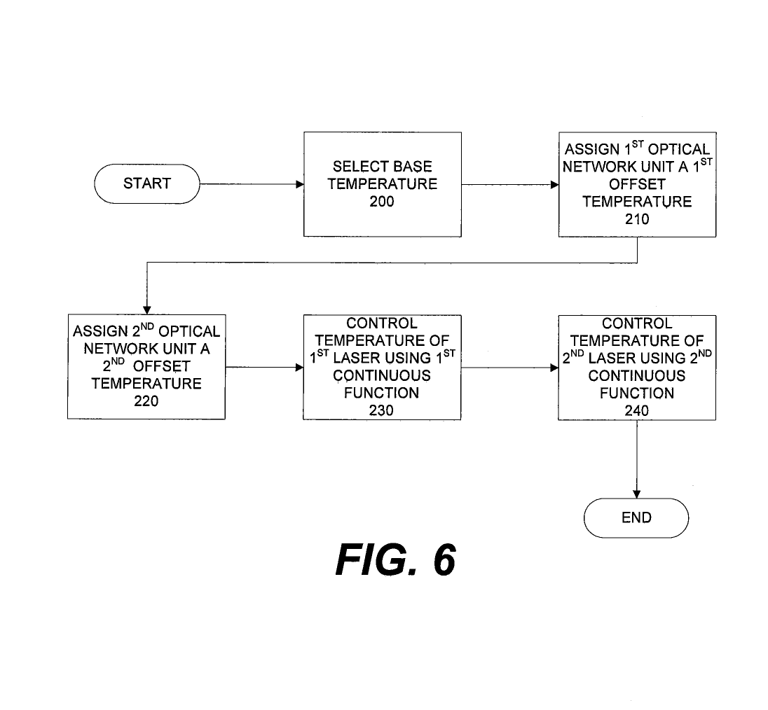

FIG. 6 is a flow chart illustrating a method according to further embodiments of the present invention. As shown in FIG. 6, operations may begin by selecting a base temperature (block 200). A first offset temperature from this base temperature may then be assigned to a first optical network unit (block 210) and a second offset temperature from this base temperature may be assigned to a second optical network unit (block 220). The first and second offset temperatures may be different from each other. The temperature of a laser of the first optical network unit may then be controlled using a first continuous function so that the temperature continuously varies about the sum of the base temperature and the first temperature offset (block 230). The temperature of a laser of the second optical network unit may then be controlled using a second continuous function so that the temperature continuously varies about the sum of the base temperature and the second temperature offset (block 240).

It will be appreciated that optical network units may also be referred to as network interface units (“NIUs”), RFoG optical network units (“RONUs”) and optical network terminals (“ONTs”). There may be minor differences between these devices in construction or application which is why they may be referred to using these different names. As used herein, the term optical network unit will be used to generically refer to RONUs, NIUs and ONTs.

The present invention has been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. are used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements and/or components, but do not preclude the presence or addition of one or more other features, operations, elements, components and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of reducing optical beat interference at a receiver in a fiber optic network that has a plurality of optical network units communicating with the receiver over a common optical transmission path, the method comprising:
controlling an output of a first temperature control system that establishes an operating temperature of a first laser that is included in a first of the optical network units so that the operating temperature of the first laser varies according to a first continuous function that has a first amplitude and a first frequency; and
controlling an output of a second temperature control system that establishes an operating temperature of a second laser that is included in a second of the optical network units so that the operating temperature of the second laser varies according to a second continuous function that has a second amplitude and a second frequency,
wherein the first continuous function is different than the second continuous function, the first amplitude is different than the second amplitude, and/or the first frequency is different than the second frequency.

2. The method of claim 1, wherein the first continuous function varies the operating temperature of the first laser from a first nominal temperature, wherein the first nominal temperature is a base temperature adjusted by a first temperature offset, and wherein the second continuous function varies the operating temperature of the second laser from a second nominal temperature, wherein the second nominal temperature is the base temperature adjusted by a second temperature offset.

3. The method of claim 2, wherein the first temperature offset is selected to be within a first predefined range and the second temperature offset is selected to be within a second predefined range that is different than the first predefined range.

4. The method of claim 3, wherein the first temperature offset is randomly selected within the first predefined range and the second temperature offset is randomly selected within the second predefined range.

5. The method of claim 3, wherein the first predefined range and the second predefined range partially overlap.

6. The method of claim 1, wherein the first amplitude is different from the second amplitude and the first frequency is different from the second frequency.

7. The method of claim 6, wherein the first and second amplitudes are randomly selected within a predetermined range and/or the first and second frequencies are randomly selected within a predetermined range.

8. The method of claim 1, wherein the first continuous function is one of a sinusoidal function or a sawtooth function.

9. The method of claim 1, wherein the first continuous function is the same type of function as the second continuous function.

10. An optical network unit, comprising:
a laser adapted to generate an optical signal having a given wavelength at a given temperature;
a temperature control system that is thermally coupled to the laser that establishes an operating temperature of the laser; and
a controller that is configured to set the operating temperature of the laser at a predefined base temperature and to automatically vary the operating temperature of the laser within a predefined range from the base temperature pursuant to a continuous function that has a first amplitude and a first frequency.

11. The optical network unit of claim 10, wherein the laser is a first laser, the continuous function comprises a first continuous function and the base temperature comprises a first base temperature, and wherein a first amplitude of the first continuous function is different than a second amplitude of a second continuous function that is used to automatically vary an operating temperature of a second laser of a second optical network unit within a predefined range from a second base temperature, wherein the second laser communicates over a common optical fiber with the first laser.

12. The optical network unit of claim 11, wherein the first base temperature comprises the sum of a common base temperature and a first temperature offset, the second base temperature comprises the sum of the common base temperature and a second temperature offset, and wherein the first temperature offset is different from the second temperature offset.

13. The optical network of claim 10, wherein the laser is a first laser, the continuous function comprises a first continuous function and the base temperature comprises a first base temperature, and wherein a first frequency of the first continuous function is different than a second frequency of a second continuous function that is used to automatically vary an operating temperature of a second laser of a second optical network unit within a predefined range from a second base temperature, wherein the second laser communicates over a common optical fiber with the first laser.

14. The optical network of claim 11, wherein a first frequency of the first continuous function is different than a second frequency of a second continuous function.

15. The optical network of claim 10, wherein the temperature control system comprises a thermoelectric cooler.

16. A method of reducing optical beat interference in a fiber optic network that has a plurality of optical network units having lasers that transmit at a common nominal wavelength to communicate with a shared receiver over a common optical transmission path, the method comprising:
providing a temperature control system at each optical network unit that is thermally coupled to the respective laser at each optical network unit;
using the temperature control systems to establish operating temperatures of the respective lasers;
automatically varying the thermal output of each of the temperature control systems according to respective continuous functions in order to automatically vary the operating temperature of each of the lasers,
wherein at least one of the continuous function, the amplitude of the continuous function and/or the frequency of the continuous function used to vary the thermal output of the temperature control system that establishes the operating temperature of the laser of a first of the optical network units differs from the respective continuous function, the amplitude of the continuous function and/or the frequency of the continuous function used to vary the thermal output of the temperature control system that establishes the operating temperature of the laser of a second of the optical network units.

17. The method of claim 16, further comprising assigning a base temperature to the laser of each of the optical network units, wherein at least some of the lasers are assigned different base temperatures, and wherein automatically varying the thermal output of each of the temperature control systems according to respective continuous functions in order to automatically vary the operating temperature of each of the lasers comprise automatically varying the thermal output of each of the temperature control systems according to respective continuous functions in order to automatically vary the operating temperature of each of the lasers about the respective base temperature for each of the lasers.

18. The method of claim 16, wherein the amplitude and/or the frequency of at least some of the continuous functions are selected to be within a respective predefined amplitude range or a predefined frequency range.

19. The method of claim 17, wherein the amplitude and/or the frequency of at least some of the continuous functions are randomly assigned within the respective predefined amplitude or frequency range.

20. The method of claim 16, wherein both the amplitude and the frequency of at least some of the continuous functions differ from the amplitude and the frequency of at least one other of the continuous functions.
